(19) United States
(12) Patent Application Publication
(10) Pub. No.: US 2022/0335329 A1
(43) Pub. Date: Oct. 20, 2022

(54) HYPERBAND-BASED PROBABILISTIC HYPER-PARAMETER SEARCH FOR MACHINE LEARNING ALGORITHMS

(71) Applicant: EMC IP Holding Company LLC, Hopkinton, MA (US)

(72) Inventor: Eduardo Vera Sousa, Rio de Janeiro (BR)

(21) Appl. No.: 17/235,421

(22) Filed: Apr. 20, 2021

(51) Int. Cl. G06N 20/00; G06N 7/00

(52) U.S. Cl. CPC G06N 20/00; G06N 7/005

(57) ABSTRACT

One example method includes, in an initial iteration of a hyperparameter search process, randomly selecting, from an entire hyperparameter space, an initial set of one or more hyperparameters, wherein the hyperparameters are usable in a machine learning process, generating an initial Gaussian probability distribution around the initial set of hyperparameters, and generating a Gaussian probability distribution function by normalizing the initial Gaussian probability distribution to delimit an initial portion of the hyperparameter space, and the initial portion of the hyperparameter space is smaller than the hyperparameter space.

### FIELD OF THE INVENTION

Embodiments of the present invention generally relate to machine learning. More particularly, at least some embodiments of the invention relate to systems, hardware, software, computer-readable media, and methods for hyperparameter selection for supervised machine learning models.

### BACKGROUND

Machine learning algorithms have been widely applied across a range of different tasks. The applications range from computer vision and workload orchestration to hardware improvement. One of the biggest challenges when dealing with machine learning algorithms, however, is the definition of the hyper-parameters of each technique. For neural networks, for example, the correct selection of the number of neurons in each layer may lead smaller validation losses. For decision trees, the height of the tree may improve the quality of a classification task and so on.

Hyperband is an algorithm based on a random search which uses an early stopping mechanism for bad runs. In practice, this approach randomly selects parameters and runs a successive halving algorithm considering a budget of executions. When using a Hyperband approach, the initial random selection of hyperparameters may lead to a choice that, although providing the best results as among the selected hyperparameters, is still very far from the optimal set of hyperparameters, that is, the set of hyperparameters that provides the smallest error.

Moreover, since Hyperband uses random samples of hyperparameters, it does not consider how the hyperparameters are distributed over the search space. As the dimensionality of the search space is increased, and the spatial distribution of the search space is not considered, the chances of selecting bad initial samples are correspondingly increased.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings.

FIG. 1 discloses aspects of a Hyperband algorithm.

FIG. 2 discloses aspects of an example framework for hyperparameter selection.

FIG. 3 is an error plot for a 1D parameter space.

FIG. 4 includes an error plot and a Gaussian PDF for hyperparameters.

FIG. 5 includes an error plot, and normalization of the Gaussian PDF of FIG. 4.

FIG. 6 shows selection of new hyperparameters after reduction of the search space by normalization of the Gaussian PDF.

FIG. 7 discloses an example computing entity operable to perform any of the disclosed methods, processes, and operations.

### DETAILED DESCRIPTION OF SOME EXAMPLE EMBODIMENTS

Embodiments of the present invention generally relate to machine learning. More particularly, at least some embodiments of the invention relate to systems, hardware, software, computer-readable media, and methods for hyperparameter selection for supervised machine learning models.

Thus, one specific application of some example embodiments involves the identification of hyperparameters that may be used by a machine learning process to improve the operation, or behavior, of the machine learning process. That is, the hyperparameters may, when employed in the machine learning process, improve the accuracy of results, such as predictions for example, obtained with the machine learning process.

In general, some embodiments of the invention comprise a combination of the Hyperband algorithm with a probabilistic approach to implement a framework that can run a low-cost walk on the hyperparameter search space in the direction of the optimal hyperparameters. More specifically, some embodiments embrace an iterative method for selecting hyperparameters. The method may include running the Hyperband algorithm k times and, as part of only the initial iteration of the Hyperband process, randomly selecting sets of hyperparameters from a normal probability density function (PDF) and returning, as outputs, the sets of hyperparameters that provide the smallest loss, that is, the greatest accuracy, relative to the other randomly selected sets of hyperparameters, when used in a machine learning model. For each iteration of the Hyperband process, a Gaussian probability distribution may be generated around each of the hyperparameters in the output set of hyperparameters. The Gaussian probability distributions may be summed and normalized at the end of each iteration, and the resulting probability density function used as an input to the next iteration of random selection of hyperparameters. Thus, insofar as some example embodiments employ a probabilistic approach, such example embodiments may be thought of as providing a guided random hyperparameter search, rather than a completely random hyperparameter search.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, some embodiments of the invention take advantage of the notion that there may be a higher probability of finding good hyperparameters in regions near previously selected hyperparameters that provided the lowest losses. An embodiment of the invention may reduce, or avoid, problems associated with completely random hyperparameter search and selection by enabling intelligent searching of hyperparameter spaces, which may be large and complex. An embodiment of the invention may take account of the way in which hyperparameters are distributed over a hyperparameter space. Various other useful and advantageous aspects of example embodiments are disclosed elsewhere herein. Note that a hyperparameter space may be referred to herein simply as a ‘parameter space’ or ‘space.’

It is noted that embodiments of the invention, whether claimed or not, cannot be performed, practically or otherwise, in the mind of a human. As indicated by the illustrative examples disclosed herein, embodiments of the invention are applicable to, and find practical usage in, systems and environments in which complex processes and analyses, such as hyperparameter identification and selection, probability density functions, and Gaussian probability distributions, for example, are performed on an iterative basis for large and complex hyperparameter spaces. Moreover, the hyperparameters that are identified and selected are suitable for use in machine learning processes that are beyond the capability of a human to perform practically and effectively. Thus, example embodiments embrace processes that are well beyond the mental capabilities of any human to perform practically, or otherwise. Moreover, while simplistic examples may be disclosed herein, those are only for the purpose of illustration and to simplify the discussion. Accordingly, nothing herein should be construed as teaching or suggesting that any aspect of any embodiment of the invention could or would be performed, practically or otherwise, in the mind of a human.

### A. Overview

The quality of machine learning algorithms is, in general, deeply related to the selection of hyperparameters. A good, or optimal, selection of hyperparameters may significantly reduce the error, or loss value, of a machine learning process, or other process, that uses the hyperparameters. In general, a loss value may be considered as capturing how well, or poorly, a model, such as a machine learning model for example, behaves when that model uses the selected hyperparameters. For example, if a model that is using particular hyperparameters accurately predicts a particular result, the loss value or error associated with those hyperparameters may be said to be relatively low. A perfectly accurate prediction may have a loss value of zero. On the other hand, if the prediction made by the model is not particularly accurate, the loss value or error of the hyperparameters may be said to be relatively high. Thus, it is useful to be able to identify and employ hyperparameters whose use results in relatively low loss values or errors.

Although exhaustive approaches for searching in the hyper-parameter search space may provide an optimal hyper-parametrization, if enough time is available to thoroughly explore the hyperparameter search space, such exhaustive approaches become unfeasible as the dimensionality of the search space increases. Other approaches, like Bayesian selection for example, do not work on categorical hyperparameters, only continuous. Hyperband is an approach that avoids the problem of search space dimensionality by randomly selecting a set of hyperparameters and keeping only the ones that provides good results, in a RANSAC-style (Random Sample Consensus) that accords relatively less, or no, influence to outlier hyperparameters. The selection of the initial set of hyperparameters for Hyperband, however, is random and, as such, there is no guarantee that this randomly selected set will provide good performance when incorporated in a model.

Thus, some example embodiments embrace a framework that combines an approach of initial random selection of a set of hyperparameters with a probabilistic selection of new hyperparameters for subsequent iterations of a hyperparameter selection process. This framework may have good applicability in an Auto-ML (Machine Learning) approach, but is not limited to identifying hyperparameters for ML processes. Experiments, examples of which are discussed elsewhere herein, indicate that this approach can be effective in obtaining good results with respect to the reduction of the loss value.

### B. Aspects of Some Example Embodiments

In general, some example embodiments of the invention are directed to an iterative method for selecting hyperparameters that may be employed, for example, in a model such as a machine learning (ML) process. Hyperparameters, which may be external to the model, may have to be set before the process is run. The identification and selection of hyperparameters may affect how well the process learns, and may also affect the accuracy of the results obtained with the process. Hyperparameters may be tunable.

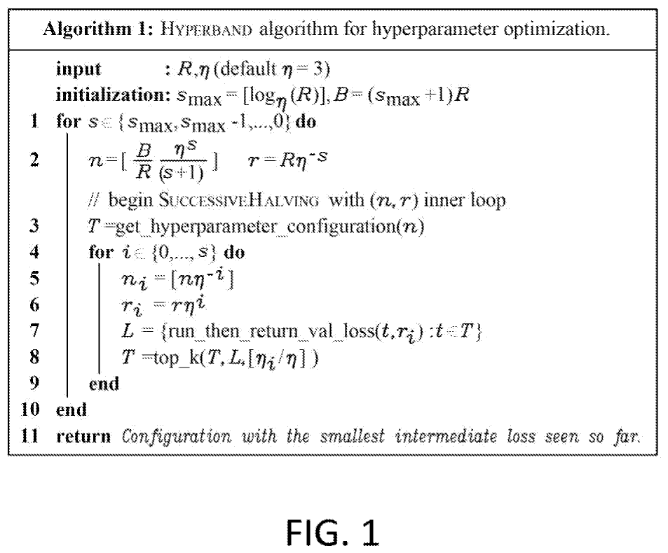

When running the example Hyperband algorithm disclosed in FIG. 1 (see, Lisha Li, Kevin Jamieson, Giulia DeSalvo, Afshin Rostamizadeh, Ameet Talwalkar; “Hyperband: A novel bandit-based approach to hyperparameter optimization,” arXiv preprint arXiv:1603.06560, 2016), sets of hyperparameters may be randomly selected from a normal probability density function (PDF), as shown in FIG. 1, and a hyperparameter optimization algorithm (HOA), one example of which is the Hyperband algorithm, may return, in a RANSAC-style for example, the set(s) of hyperparameters which provide the smallest loss, that is, the greatest accuracy, when incorporated into a process such as an ML process. It is noted that the scope of the invention is not limited to use of the Hyperband algorithm, and other hyperparameter optimization algorithms (HOA) may alternatively be employed.

With continued reference to the example of FIG. 1, the function get_hyperparameter_configuration( ) receives, as an input, the number of sets of hyperparameters and then returns randomly-selected samples of the hyperparameter space. The function run_then_return_val_loss( ) receives, as argument, one set of randomly selected hyperparameters and the number of resources, such as epochs in the case of neural network, to run an ML algorithm, and that function then returns the error associated with use of the randomly selected hyperparameters by the ML algorithm, where the error may be expressed in terms of the loss in the context of neural networks. Further, the function top_k( ) receives sets of hyperparameters, the associated losses, and the number of sets to be returned by the function. Finally, the output (Line 11) of the algorithm in FIG. 1 is the configuration, that is, the hyperparameter set, with the smallest loss identified thus far in the current set of iterations of the algorithm.

Note that, with respect to the example HOA disclosed in FIG. 1, the approach embodied by that HOA does not take into account how the hyperparameters are distributed over the hyperparameter space. On the other hand, some embodiments of the invention may enable exploration of the hyperparameter space using a probabilistic approach. Particularly, at least some embodiments of the invention incorporate the notion that there is relatively higher probability of finding good hyperparameters in regions near previously identified hyperparameters which provided relatively smaller losses when employed in an application such as an ML model. Thus, some embodiments of the invention, rather than operating on a completely random basis, operate instead on what may be referred to as a guided random basis.

In order to perform this guided random search, consideration may be given to Gaussian probability distributions centered on the hyperparameters selected from the k iterations of Hyperband. More particularly, the Hyperband algorithm may be run k times, and, for each iteration of the Hyperband algorithm, a respective Gaussian probability distribution created around the points, that is, the set of hyperparameters, returned.

The decay rate of each Gaussian probability distribution may be defined by the loss returned by the selection of each hyperparameter, scaled by a factor w. Once these Gaussian probability distributions are computed, each may be summed and normalized by a Softmax-like function (see, Ian Goodfellow, Yoshua Bengio, Aaron Courville; “Softmax Units for Multinoulli Output Distributions,” MIT Press, 2016) in order that each Gaussian probability distribution sums to 1 and becomes a probability density function (PDF). In general, a PDF may indicate a probability that a randomly selected variable will fall within a particular range of values, rather than a probability that the randomly selected variable will assume any particular value within the range.

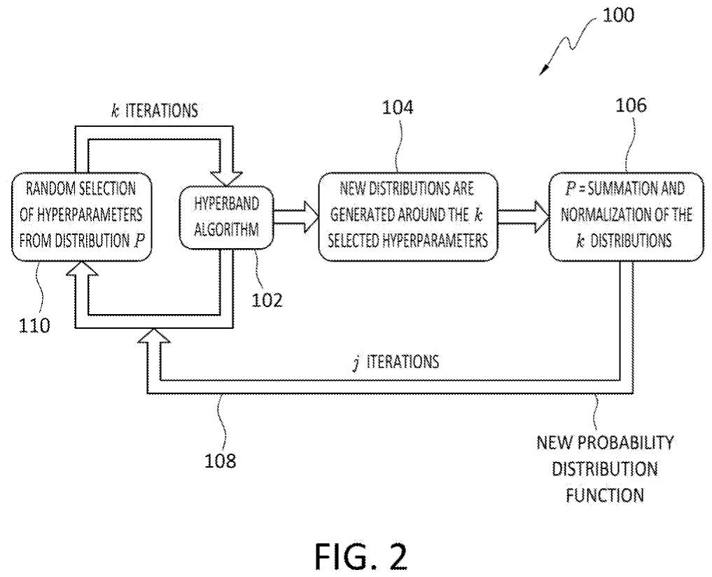

This new PDF may then be used in the next iteration of random selection of hyperparameters. That is, the hyperparameters selected in the next iteration may be randomly selected from the range of values defined by the PDF. Thus, in one sense, part of the process is random in that the hyperparameters are randomly selected, but the process is not fully random because the range from which the hyperparameters can be selected is constrained, or defined, by the PDF. That is, the hyperparameters are not randomly selected from the entire parameter space, but only from a specified portion of the parameter space. This process may be repeated in order to refine the process until a defined threshold c of error is reached. Further details concerning an example method are discussed below in connection with FIG. 2.

### D. Example Methods

It is noted with respect to the example method of FIG. 2 that any of the disclosed processes, operations, methods, and/or any portion of any of these, may be performed in response to, as a result of, and/or, based upon, the performance of any preceding process(es), methods, and/or, operations. Correspondingly, performance of one or more processes, for example, may be a predicate or trigger to subsequent performance of one or more additional processes, operations, and/or methods. Thus, for example, the various processes that may make up a method may be linked together or otherwise associated with each other by way of relations such as the examples just noted.

Directing attention now to FIG. 2, an example method 100 for hyperparameter selection is disclosed. The method 100 may begin by running 102 a hyperparameter optimization algorithm such as Hyperband to randomly select, from the entire parameter space, a set of one or more hyperparameters. A Gaussian probability distribution may then be generated 104 about each of the selected hyperparameters. Next, each of the Gaussian probability distributions may be summed and normalized 106 to generate a probability distribution function, which then serves as an input 108 to the next successive iteration of the remaining j (that is, k−1, where 1 is the initial iteration) iterations of the HOA.

In this next successive iteration, the set of parameters may be randomly selected 110 from the range defined by the probability distribution function provided at 108. The method 100 may then return to 102 to begin another iteration and the process may continue for k iterations, at the end of which, suitable hyperparameters may have been selected for use in a process such as an ML process.

While not specifically indicated in FIG. 2, each selected set of hyperparameters, after they have been selected, may be employed in a process such as an ML process, and error information gathered as a result of the running of the process with the hyperparameters. When a set of hyperparameters has been selected, and then checked in a process such as an ML process, and an acceptable error measurement achieved, the process 100 may be terminated.

### E. Further Discussion

Following is further discussion concerning aspects of some example embodiments. For example, by leveraging the spatial distribution of the hyperparameters in the hyperparameter space, example embodiments of the invention may be able to achieve a better selection of hyperparameters, without relying on a completely random approach. Additionally, embodiments may be easily adapted to categorical hyperparameter by setting, and using, the granularity of the search space discretization.

As another example, some embodiments of the invention may be scalable over the dimensionality of the parameter space, that is, over the dimensions of the entire parameter space. Although the initial selection of hyperparameters, that is, in the initial iteration, may be completely random in some embodiments, which may lead to bad selections when handling search spaces with higher dimensionality, the next loops, or iterations, may guide the search in direction that provides hyperparameters with relatively smaller associated losses when employed in a model such as an ML model for example. In fact, although the dimensionality of the space may still be relatively high, the search space is considerably reduced in size.

In connection with the foregoing, example embodiments may provide for a guided random walk over the parameter space. In contrast with typical Hyberband operation, embodiments of the invention may not rely on completely random selection of hyperparameters. Even if Hyperband were executed a few times, rather than just once, there is still no guarantee that the selected hyperparameters in each iteration are better, that is, produce lower losses, than the previously selected hyperparameters. Example embodiments of the invention may operate to restrict the search space into a volume or area of reduced size, where it may be feasible to find a better solution, that is, hyperparameters with lower losses, than the hyperparameters found in one or more of the previous iterations.

As a final example, some embodiments may provide for spatial distribution of the hyperparameters. That is, such embodiments may employ a probabilistic approach to model the space around the hyperparameters. By modeling the PDF around the parameter sets found on previous iterations, such embodiments may be able to restrict the size and/or volume of the search space around those sets of hyperparameters and take advantage of the notion that the set of hyperparameters that leads to a smaller error is closer to the hyperparameters selected on previous iteration, than to other hyperparameters that may be located elsewhere in the space.

### F. Experimental Results

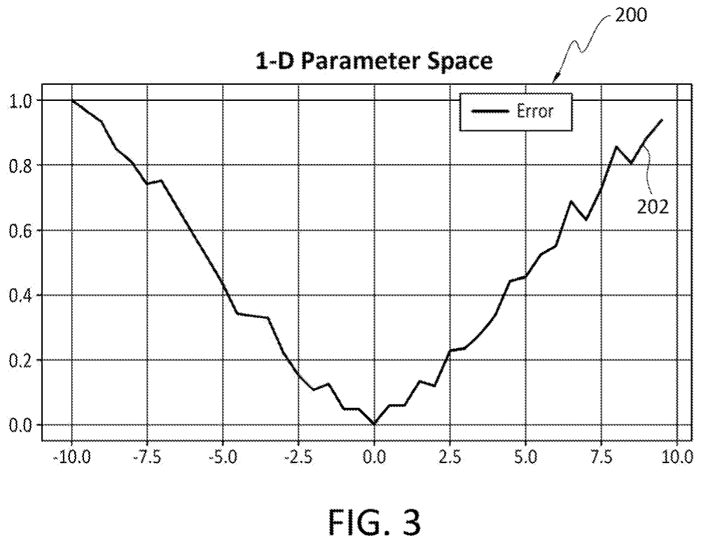

With attention now to FIGS. 3-6, details are provided concerning some example experiments performed using some example embodiments of the invention. With reference first to FIG. 3, a synthetic 1-D parameter space 200 was created. The dimensionality reduction was due to simplification of the visualization, that is, the decision was made to show the entire experiment in 1-D to see both parameter selection and PDFs simultaneously. However, one of more of the disclosed embodiments may easily be easily adapted to parameter spaces with a greater number of dimensions than 1. In more detail, FIG. 3 includes an error plot 202 for the 1D space indicating the error magnitude (Y-axis) associated with different hyperparameters (not shown in FIG. 2).

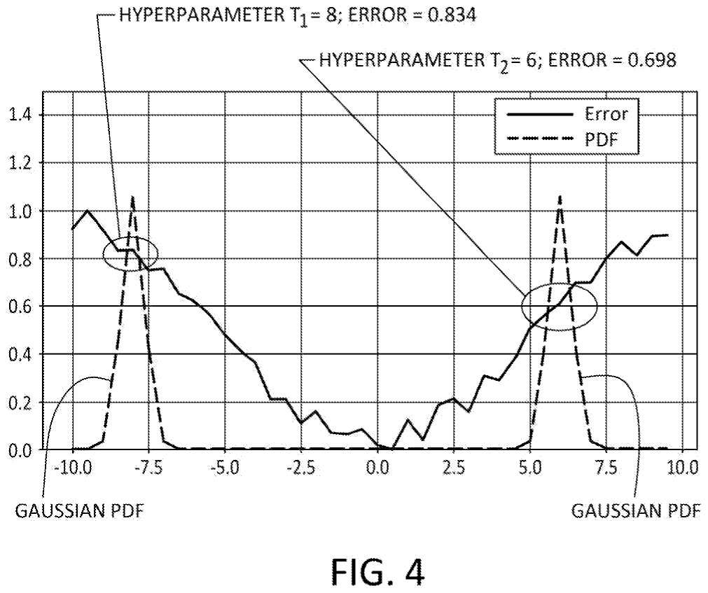

Turning next to FIG. 4, two hyperparameters were selected from two executions of hyperband, namely, hyperparameters T₁=8, and T₂=6. The respective errors associated with those hyperparameters were determined to be to 0.834 and 0.698. As further indicated in the example of FIG. 4, a Gaussian PDF was composed that included respective portions around each of T₁ and T₂.

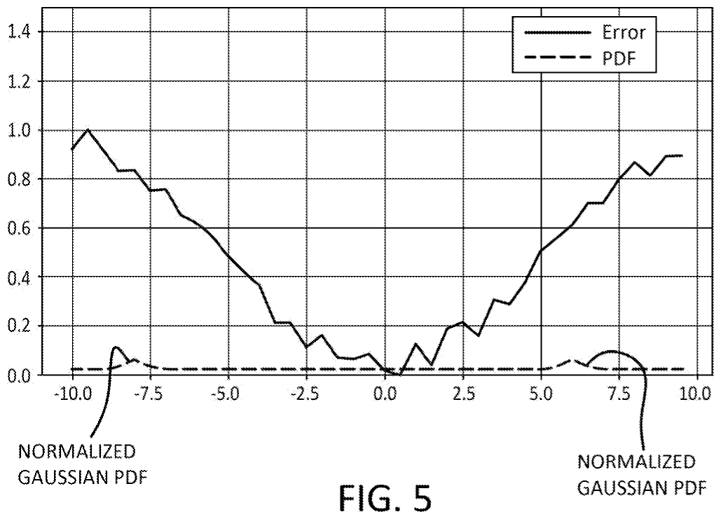

In the example of FIG. 5, the Gaussian PDF of FIG. 4 has been normalized, such as with a Softmax function for example. It can be seen in FIG. 5 that the total space from which hyperparameters may be randomly selected in the next iteration, that is, the space under the Gaussian PDF curve, has been considerably reduced. Thus, while the selection may be random, the parameter space from which the random selection will be made has been sufficiently reduced in size to ensure that the next set of parameters will have lower errors than the set of hyperparameters that was initially selected (see FIG. 4).

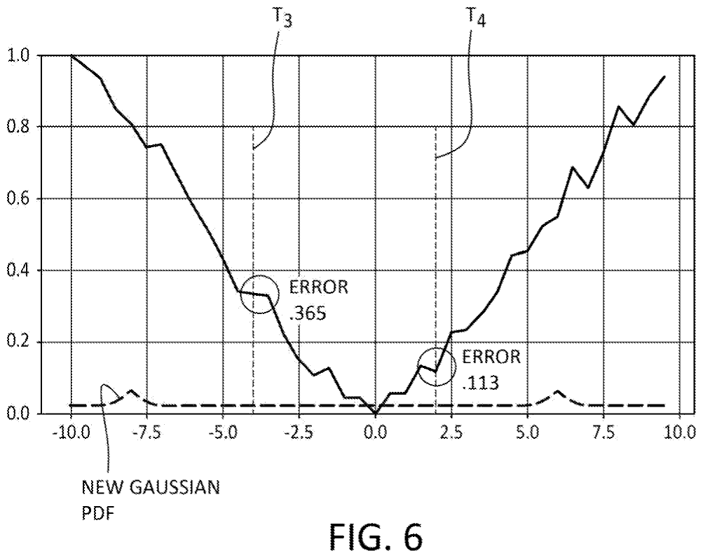

In the next iteration, and as shown in FIG. 6, hyperparameters T₃ and T₄, indicated by the dashed lines, were selected from the new Gaussian PDF that was defined by normalization of the initial Gaussian PDF in the prior iteration. As indicated, the new hyperparameter sets T₃ and T₄ have errors equals to 0.365 and 0.113, respectively. Notice that while the errors in a subsequent iteration could be larger than the ones provided by the initial selection, the system would eventually converge to reduce the error and, with sufficient time, provide optimal, or at least improved, results.

### G. Further Example Embodiments

Following are some further example embodiments of the invention. These are presented only by way of example and are not intended to limit the scope of the invention in any way.

Embodiment 1. A method, comprising: in an initial iteration of a hyperparameter search process: randomly selecting, from an entire hyperparameter space, an initial set of one or more hyperparameters, wherein the hyperparameters are usable in a machine learning process; generating an initial Gaussian probability distribution around the initial set of hyperparameters; and generating a Gaussian probability distribution function by normalizing the initial Gaussian probability distribution to delimit an initial portion of the hyperparameter space, and the initial portion of the hyperparameter space is smaller than the hyperparameter space.

Embodiment 2. The method as recited in embodiment 1, further comprising: in a subsequent iteration of the hyperparameter search process, wherein the subsequent iteration is performed at some time after the initial iteration: randomly selecting, from the portion of the hyperparameter space, a subsequent set of one or more hyperparameters; generating a subsequent Gaussian probability distribution around the subsequent set of hyperparameters; and generating a subsequent Gaussian probability distribution function by generating a sum that includes the subsequent Gaussian probability distribution and the initial Gaussian probability distribution, and then normalizing the subsequent Gaussian probability distribution to delimit a subsequent portion of the hyperparameter space, and the subsequent portion of the hyperparameter space is smaller than the hyperparameter space.

Embodiment 3. The method as recited in embodiment 2, further comprising running a machine learning process using one of the sets of hyperparameters and, based on the running of the machine learning process, determining a respective magnitude of error attributable to each hyperparameter in that set of hyperparameters used in the machine learning process.

Embodiment 4. The method as recited in embodiment 3, wherein the magnitude of the error determines whether or not one or more additional iterations of the hyperparameter search process should be performed.

Embodiment 5. The method as recited in embodiment 3, further comprising iterating the method until an error decreases to a value that is less than or equal to a specified error value is achieved.

Embodiment 6. The method as recited in any of embodiments 1-5, wherein the initial iteration of the hyperparameter search process is performed using the Hyperband algorithm.

Embodiment 7. The method as recited in any of embodiments 1-6, wherein the machine learning process is a supervised machine learning process.

Embodiment 8. The method as recited in embodiment 2, wherein the subsequent set of one or more hyperparameters, when employed in the machine learning process, improve results of the machine learning process relative to results of the machine learning process that were generated based on use, by the machine learning process, of the initial set of one or more hyperparameters.

Embodiment 9. A method for performing any of the operations, methods, or processes, or any portion of any of these, disclosed herein.

Embodiment 10. A non-transitory storage medium having stored therein instructions that are executable by one or more hardware processors to perform operations comprising the operations of any one or more of embodiments 1-9.

### H. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

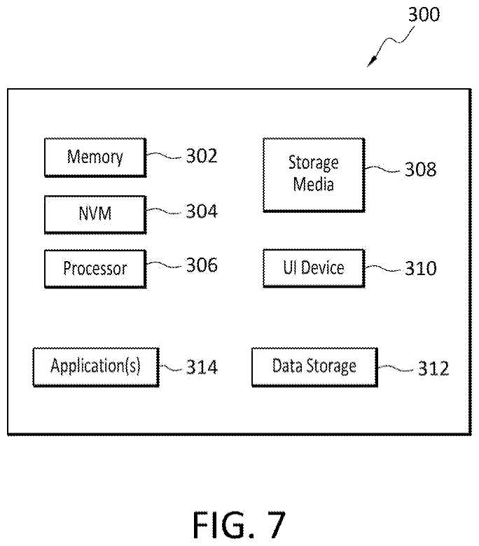

With reference briefly now to FIG. 7, any one or more of the entities disclosed, or implied, by FIGS. 1-6 and/or elsewhere herein, may take the form of, or include, or be implemented on, or hosted by, a physical computing device, one example of which is denoted at 300. As well, where any of the aforementioned elements comprise or consist of a virtual machine (VM), that VM may constitute a virtualization of any combination of the physical components disclosed in FIG. 7.

In the example of FIG. 7, the physical computing device 300 includes a memory 302 which may include one, some, or all, of random access memory (RAM), non-volatile memory (NVM) 304 such as NVRAM for example, read-only memory (ROM), and persistent memory, one or more hardware processors 306, non-transitory storage media 308, UI device 310, and data storage 312. One or more of the memory components 302 of the physical computing device 300 may take the form of solid state device (SSD) storage. As well, one or more applications 314 may be provided that comprise instructions executable by one or more hardware processors 306 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
in an initial iteration of a hyperparameter search process:
randomly selecting, from an entire hyperparameter space, an initial set of one or more hyperparameters, wherein the hyperparameters are usable in a machine learning process;
generating an initial Gaussian probability distribution around the initial set of hyperparameters; and
generating a Gaussian probability distribution function by normalizing the initial Gaussian probability distribution to delimit an initial portion of the hyperparameter space, and the initial portion of the hyperparameter space is smaller than the hyperparameter space.

2. The method as recited in claim 1, further comprising:
in a subsequent iteration of the hyperparameter search process, wherein the subsequent iteration is performed at some time after the initial iteration:
randomly selecting, from the portion of the hyperparameter space, a subsequent set of one or more hyperparameters;
generating a subsequent Gaussian probability distribution around the subsequent set of hyperparameters; and
generating a subsequent Gaussian probability distribution function by generating a sum that includes the subsequent Gaussian probability distribution and the initial Gaussian probability distribution, and then normalizing the subsequent Gaussian probability distribution to delimit a subsequent portion of the hyperparameter space, and the subsequent portion of the hyperparameter space is smaller than the hyperparameter space.

3. The method as recited in claim 2, further comprising running a machine learning process using one of the sets of hyperparameters and, based on the running of the machine learning process, determining a respective magnitude of error attributable to each hyperparameter in that set of hyperparameters used in the machine learning process.

4. The method as recited in claim 3, wherein the magnitude of the error determines whether or not one or more additional iterations of the hyperparameter search process should be performed.

5. The method as recited in claim 3, further comprising iterating the method until an error decreases to a value that is less than or equal to a specified error value is achieved.

6. The method as recited in claim 1, wherein the initial iteration of the hyperparameter search process is performed using the Hyperband algorithm.

7. The method as recited in claim 1, wherein the machine learning process is a supervised machine learning process.

8. The method as recited in claim 2, wherein the subsequent set of one or more hyperparameters, when employed in the machine learning process, improve results of the machine learning process relative to results of the machine learning process that were generated based on use, by the machine learning process, of the initial set of one or more hyperparameters.

9. A computer readable storage medium having stored therein instructions that are executable by one or more hardware processors to perform operations comprising:
in an initial iteration of a hyperparameter search process:
randomly selecting, from an entire hyperparameter space, an initial set of one or more hyperparameters, wherein the hyperparameters are usable in a machine learning process;
generating an initial Gaussian probability distribution around the initial set of hyperparameters; and
generating a Gaussian probability distribution function by normalizing the initial Gaussian probability distribution to delimit an initial portion of the hyperparameter space, and the initial portion of the hyperparameter space is smaller than the hyperparameter space.

10. The computer readable storage medium as recited in claim 9, wherein the operations further comprise:
in a subsequent iteration of the hyperparameter search process, wherein the subsequent iteration is performed at some time after the initial iteration:
randomly selecting, from the portion of the hyperparameter space, a subsequent set of one or more hyperparameters;
generating a subsequent Gaussian probability distribution around the subsequent set of hyperparameters; and
generating a subsequent Gaussian probability distribution function by generating a sum that includes the subsequent Gaussian probability distribution and the initial Gaussian probability distribution, and then normalizing the subsequent Gaussian probability distribution to delimit a subsequent portion of the hyperparameter space, and the subsequent portion of the hyperparameter space is smaller than the hyperparameter space.

11. The computer readable storage medium as recited in claim 10, wherein the operations further comprise running a machine learning process using one of the sets of hyperparameters and, based on the running of the machine learning process, determining a respective magnitude of error attributable to each hyperparameter in that set of hyperparameters used in the machine learning process.

12. The computer readable storage medium as recited in claim 11, wherein the magnitude of the error determines whether or not one or more additional iterations of the hyperparameter search process should be performed.

13. The computer readable storage medium as recited in claim 11, further comprising iterating the operations until an error decreases to a value that is less than or equal to a specified error value is achieved.

14. The computer readable storage medium as recited in claim 9, wherein the initial iteration of the hyperparameter search process is performed using the Hyperband algorithm.

15. The computer readable storage medium as recited in claim 9, wherein the machine learning process is a supervised machine learning process.

16. The computer readable storage medium as recited in claim 10, wherein the subsequent set of one or more hyperparameters, when employed in the machine learning process, improve results of the machine learning process relative to results of the machine learning process that were generated based on use, by the machine learning process, of the initial set of one or more hyperparameters.

17. A system, comprising:
one or more hardware processors; and
a computer readable storage medium having stored therein instructions that are executable by the one or more hardware processors to perform operations comprising:
in an initial iteration of a hyperparameter search process:
randomly selecting, from an entire hyperparameter space, an initial set of one or more hyperparameters, wherein the hyperparameters are usable in a machine learning process;
generating an initial Gaussian probability distribution around the initial set of hyperparameters; and
generating a Gaussian probability distribution function by normalizing the initial Gaussian probability distribution to delimit an initial portion of the hyperparameter space, and the initial portion of the hyperparameter space is smaller than the hyperparameter space.

18. The system as recited in claim 17, wherein the operations further comprise:
in a subsequent iteration of the hyperparameter search process, wherein the subsequent iteration is performed at some time after the initial iteration:
randomly selecting, from the portion of the hyperparameter space, a subsequent set of one or more hyperparameters;
generating a subsequent Gaussian probability distribution around the subsequent set of hyperparameters; and
generating a subsequent Gaussian probability distribution function by generating a sum that includes the subsequent Gaussian probability distribution and the initial Gaussian probability distribution, and then normalizing the subsequent Gaussian probability distribution to delimit a subsequent portion of the hyperparameter space, and the subsequent portion of the hyperparameter space is smaller than the hyperparameter space.

19. The system as recited in claim 18, wherein the subsequent set of one or more hyperparameters, when employed in the machine learning process, improve results of the machine learning process relative to results of the machine learning process that were generated based on use, by the machine learning process, of the initial set of one or more hyperparameters.

20. The system as recited in claim 18, wherein the operations further comprise running a machine learning process using one of the sets of hyperparameters and, based on the running of the machine learning process, determining a respective magnitude of error attributable to each hyperparameter in that set of hyperparameters used in the machine learning process.
